(19) United States
(12) Patent Application Publication
(10) Pub. No.: US 2022/0120456 A1
(43) Pub. Date: Apr. 21, 2022

(54) WATER REPLENISHMENT STRUCTURE ATOMIZATION DEVICE AND HUMIDIFIER

(71) Applicant: SHENZHEN QIANHAI PATUOXUN NETWORK AND TECHNOLOGY CO., LTD, Shenzhen (CN)

(72) Inventors: Mingyang Liu, Shenzhen (CN); Yunxiao Liu, Shenzhen (CN); Ping Zheng, Shenzhen (CN)

(21) Appl. No.: 17/186,068

(22) Filed: Feb. 26, 2021

(30) Foreign Application Priority Data
Oct. 21, 2020 (CN) 202011135610.4

(51) Int. Cl. F24F 6/14

(52) U.S. Cl. CPC F24F 6/14; F24F 2006/008

(57) ABSTRACT

The present application discloses a water replenishment structure, an atomization device and a humidifier. the water replenishment structure includes: a floating member located in the water storage container; a linkage whose one end connecting with the floating member, the other end extending out from the water storage container through the water inlet hole, a radial size of the linkage is smaller than that of the water inlet hole; a sealing gasket provided outside the water storage container and provided corresponding to a water inlet end of the water inlet hole, a radial size of the sealing gasket is larger than that of the water inlet hole, the sealing gasket is connected with a part of the linkage extending out from the water storage container to move with a movement of the linkage.

### CROSS REFERENCE TO RELATED APPLICATIONS

The present application claims the benefit of Chinese Patent Application No. 202011135610.4 filed on Oct. 21, 2020, the contents of which are incorporated herein by reference in their entirety.

### TECHNICAL FIELD

The present application relates to the technical field of humidifiers, in particular to a water replenishment structure, an atomization device and a humidifier.

### BACKGROUND

A humidifier is an electrical appliance for increasing the humidity of the environment. With the improvement of people's living standard and the increasing requirement for air quality, the humidifier is gradually being favored by people. There are also various kinds of humidifiers on the market, such as ultrasonic, pure, and electric heating humidifiers. Current humidifier generally includes a water tank component for storing solution and an atomization component for atomizing water. The atomization component has an atomization chamber. It can be realized by setting a water replenishment component to automatically replenish the water in the water tank into the atomization chamber. However, the current water replenishment component has a complicated structure, is not easy to be assembled or disassembled, and does not facilitate cleaning.

### SUMMARY

A main purpose of the present application is to provide a water replenishment structure, which intends to improve the convenience of the installation and disassembly of the water replenishment structure, so as to facilitate cleaning the water replenishment structure and a related product using the water replenishment structure.

In order to achieve the above objective, the present application proposes a water replenishment structure used for a water storage container, a water inlet hole is provided on a side wall or a bottom of the water storage container, the water replenishment structure is provided corresponding to the water inlet hole;

the water replenishment structure comprises:

a floating member located in the water storage container;

a linkage whose one end connecting with the floating member, the other end extending out from the water storage container through the water inlet hole, a radial size of the linkage is smaller than that of the water inlet hole;

a sealing gasket provided outside the water storage container and provided corresponding to a water inlet end of the water inlet hole, a radial size of the sealing gasket is larger than that of the water inlet hole, the sealing gasket is connected with a part of the linkage extending out from the water storage container to move with a movement of the linkage.

Optionally, the water replenishment structure further comprises an elastic member provided outside the water storage container, one end of the elastic member corresponds to an outer side wall of the water storage container, and the other end is connected with the sealing gasket.

Optionally, the elastic member is provided inside the water storage container, one end of the elastic member is fixedly connected with an inner side wall of the water storage container around the water inlet hole, and the other end is fixedly connected with the linkage or the floating member.

Optionally, the elastic member comprises a spring sleeved on the linkage;

there is a snap groove on a side of the sealing gasket facing the water inlet hole, and one end of the spring is stuck in the snap groove.

Optionally, a deformation groove is formed on the side of the sealing gasket facing the water inlet hole, a notch of the deformation groove allows the spring to get in and out the deformation groove, the snap groove is formed on a groove bottom of the deformation groove.

Optionally, the elastic member comprises a spring sleeved on the linkage.

Optionally, a deformation groove is formed on the side of the sealing gasket facing the water inlet hole, a notch of the deformation groove allows the spring to get in and out the deformation groove, the snap groove is formed on a groove bottom of the deformation groove.

Optionally, a connection hole is provided in a middle of the sealing gasket, one end of the linkage fitting with the sealing gasket is inserted into the connection hole;

an end of the linkage connected with the sealing gasket is provided with an elastic groove, and an inverted buckle is provided on an outer side wall of the linkage.

Optionally, a guiding sleeve is provided at a position corresponding to the water inlet hole on the inner side wall of the water storage container to guide the linkage to move along a preset direction.

Optionally, the water replenishment structure further comprises a sealing nozzle having a water passage, the sealing nozzle is provided corresponding to the water inlet end of the water inlet hole so that one end of the water passage is intercommunicated with the water inlet end, and the other end is provided protruding from the water inlet hole.

Optionally, the sealing nozzle is provided in a trumpet shape, a large diameter end of the sealing nozzle is fixedly connected with the outer side wall of the water storage container corresponding to the water inlet end of the water inlet hole, a small diameter end protrudes and extends in a direction away from the water inlet hole.

Optionally, the water replenishment structure further comprises a sealing nozzle having a water passage, the sealing nozzle is provided corresponding to the water inlet end of the water inlet hole so that one end of the water passage is intercommunicated with the water inlet end, and the other end is provided protruding from the water inlet hole.

The present application further proposes an atomization device comprising a water storage container, an atomizer and a water replenishment structure, a water inlet hole is provided on a side wall or a bottom of the water storage container, the water replenishment structure is provided corresponding to the water inlet hole;

the water replenishment structure comprises:

a floating member located in the water storage container;

a linkage whose one end connecting with the floating member, the other end extending out from the water storage container through the water inlet hole, a radial size of the linkage is smaller than that of the water inlet hole;

a sealing gasket provided outside the water storage container and provided corresponding to a water inlet end of the water inlet hole, a radial size of the sealing gasket is larger than that of the water inlet hole, the sealing gasket is connected with a part of the linkage extending out from the water storage container to move with a movement of the linkage;

the atomizer is provided inside the water storage container.

Optionally, the water replenishment structure further comprises an elastic member provided outside the water storage container, one end of the elastic member corresponds to an outer side wall of the water storage container, and the other end is connected with the sealing gasket, or

the elastic member is provided inside the water storage container, one end of the elastic member is fixedly connected with an inner side wall of the water storage container around the water inlet hole, and the other end is fixedly connected with the linkage or the floating member.

Optionally, the elastic member comprises a spring sleeved on the linkage;

there is a snap groove on a side of the sealing gasket facing the water inlet hole, and one end of the spring is stuck in the snap groove;

a deformation groove is formed on the side of the sealing gasket facing the water inlet hole, a notch of the deformation groove allows the spring to get in and out the deformation groove, the snap groove is formed on a groove bottom of the deformation groove.

The present application further proposes a humidifier comprising a water tank and an atomization device;

the atomization device comprises a water storage container, an atomizer, and a water replenishment structure, a water inlet hole is provided on a side wall or a bottom of the water storage container, the water replenishment structure is provided corresponding to the water inlet hole;

the water replenishment structure comprises:

a floating member located in the water storage container;

a linkage whose one end connecting with the floating member, the other end extending out from the water storage container through the water inlet hole, a radial size of the linkage is smaller than that of the water inlet hole;

a sealing gasket provided outside the water storage container and provided corresponding to a water inlet end of the water inlet hole, a radial size of the sealing gasket is larger than that of the water inlet hole, the sealing gasket is connected with a part of the linkage extending out from the water storage container to move with a movement of the linkage;

the water replenishment structure is installed corresponding to the water inlet hole of the water storage container, the atomizer is provided inside the water storage container;

the water storage container is intercommunicated with the water tank through the water inlet hole.

Optionally, the water storage container is installed inside the water tank, the water inlet hole is located at a bottom of the water storage container, there is a water inlet gap between the bottom of the water storage container and the bottom of the water tank.

Optionally, an avoidance groove is formed at a position of the water storage container corresponding to the sealing gasket to accommodate the sealing gasket.

Optionally, a support table is formed at the opening of a box, the water storage container comprises a water storage part and a mounting plate arranged around the opening of the water storage part, the edge of the mounting plate is overlapped on the support table.

Optionally, the water replenishment structure further comprises an elastic member provided outside the water storage container, one end of the elastic member corresponds to an outer side wall of the water storage container, and the other end is connected with the sealing gasket; or,

the elastic member is provided inside the water storage container, one end of the elastic member is fixedly connected with an inner side wall of the water storage container around the water inlet hole, and the other end is fixedly connected with the linkage or the floating member.

In the technical solution of the present application, the floating member and the sealing gasket are provided inside and outside the liquid storage bucket respectively, and are connected by a linkage, so that the liquid enter the water storage container from the gap between the linkage and the water inlet hole when it flows to the water inlet end of the water inlet hole at a certain pressure. As the liquid in the water storage container increases, the floating member will rise with the liquid level. As the floating member rises, the linkage drives the sealing member to move upward. When the liquid level reaches a preset position, the sealing gasket is attached to the water inlet end of the water inlet hole to seal the water inlet end to prevent the liquid from continuing to enter the water storage container. When the liquid in the water storage container is consumed and the liquid level drops, the floating member moves downward with the liquid level, the sealing gasket moves downward with the floating member and leaves the water inlet end of the water inlet hole, so that the water inlet end is opened and the liquid can continue to enter water storage container through the water inlet end.

### BRIEF DESCRIPTION OF THE DRAWINGS

In order to describe the technical solutions in the embodiments of the present application or in the prior art more clearly, the drawings that need to be used in the description of the embodiments or the prior art will be introduced briefly as follows. Obviously, the drawings in the following description are only some embodiments of the present application. For one skilled in the art, other drawings may be obtained according to the structure shown in these drawings without creative work.

FIG. 1 is a structural schematic diagram of a humidifier according to an embodiment of the present application;

FIG. 2 is an internal structural schematic diagram of a humidifier according to an embodiment of the present application;

FIG. 3 is a structural schematic diagram of a water replenishment structure according to an embodiment of the present application;

FIG. 4 is an internal structural schematic diagram of a humidifier according to another embodiment of the present application;

FIG. 5 is a partial enlarged view of A in FIG. 4;

FIG. 6 is a structural schematic diagram of a humidifier according to another embodiment of the present application;

FIG. 7 is a cross-sectional structural schematic diagram at M-M in FIG. 6;

FIG. 8 is a partial enlarged view of B in FIG. 7.

### DESCRIPTION OF THE LABELS IN THE DRAWINGS

| label | name |
|---|---|
| 100 | water tank |
| 110 | support table |
| 120 | water inlet gap |
| 200 | fan |
| 210 | air outlet |
| 300 | water replenishment structure |
| 310 | floating member |
| 320 | linkage |
| 321 | elastic groove |
| 322 | inverted buckle |
| 330 | sealing gasket |
| 331 | deformation groove |
| 332 | snap groove |
| 333 | connection hole |
| 350 | elastic member |
| 500 | atomizer container |
| 600 | water storage |
| 610 | atomication chamber |
| 620 | water inlet hole |
| 621 | water inlet end |
| 622 | water outlet end |
| 630 | guiding sleeve |
| 650 | avoidance groove |
| 660 | sealing nozzle |
| 661 | water passage |
| 700 | mounting plate |

The implementation of the purpose, the functional characteristics and the advantages of the present application will be further described in conjunction with the embodiments and with reference to the accompanying drawings.

### DETAILED DESCRIPTION

The technical solutions in the embodiments of the present application will be described clearly and completely in conjunction with the drawings in the embodiments of the present application as follows. Obviously, the described embodiments are only a part of the embodiments of the present application, rather than all of the embodiments. Based on the embodiments in the present application, all other embodiments obtained by one skilled in the art without creative work shall fall within the protective scope of the present application.

It is necessary to be noted that all directional indications (such as up, down, left, right, front, back . . . ) in the embodiments of the present application are only used to explain the relative position relationship, movement situation and so on between various components in a particular posture (as shown in the drawings). If the particular posture changes, the directional indication will change accordingly.

In addition, the descriptions related to “first”, “second” and so on in the present application are only for descriptive purpose, and cannot be understood as indicating or implying their relative importance or implicitly indicating the number of indicated technical features. Thereby, the features defined with “first” and “second” may include at least one of the features explicitly or implicitly. In addition, “and/or” herein includes three solutions, taking A and/or B as an example, includes the A technical solution, the B technical solution, and the technical solution that meets A and B at the same time. In addition, the technical solutions of the various embodiments can be combined with each other, but it must be combined based on what can be achieved by one skilled in the art. When the combination of the technical solutions is contradictory or cannot be implemented, it should be considered that this combination of the technical solutions does not exist, nor is within the protective scope claimed in the present application.

The present application mainly proposes a water replenishment structure 300, which is mainly used in an atomization device, so that the water in the water tank 100 can replenish water in the atomization chamber 610 automatically. The water replenishment structure 300 is easy to be assembled and disassembled, and is beneficial to the replacement, maintenance and cleaning of the water replenishment structure 300, and is also beneficial to the cleaning of the vapor chamber and the water tank 100 meanwhile.

The specific structure of the water replenishment structure 300 will be mainly described as follows.

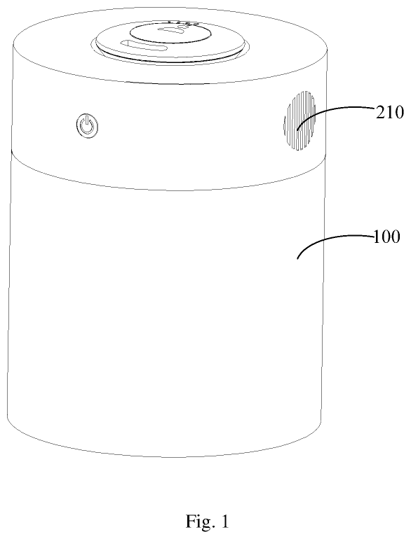

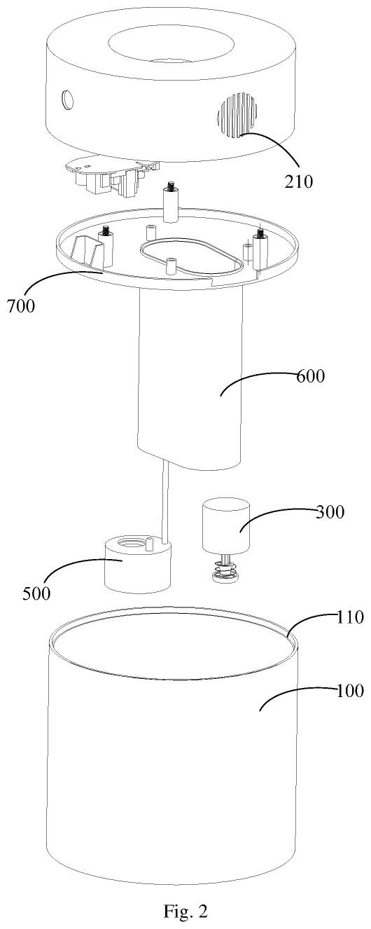

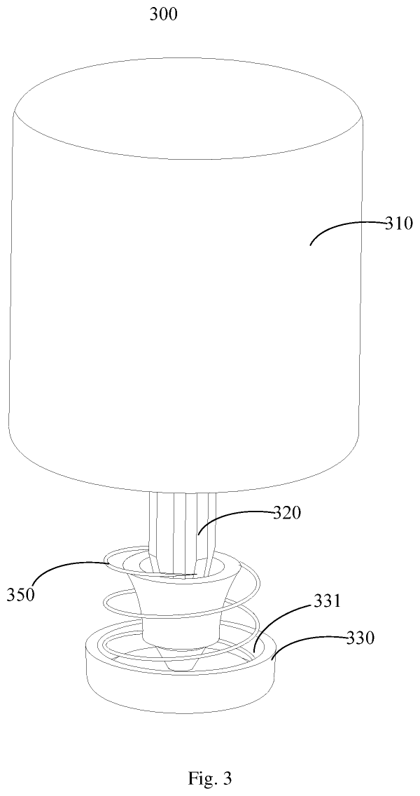

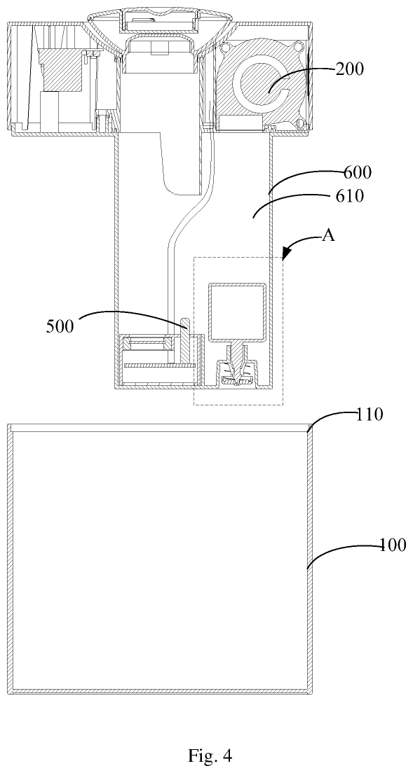

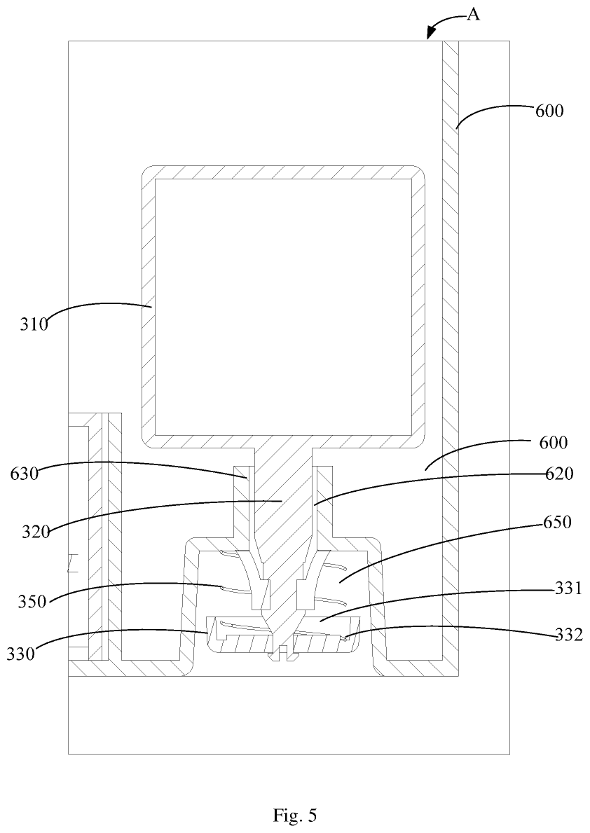

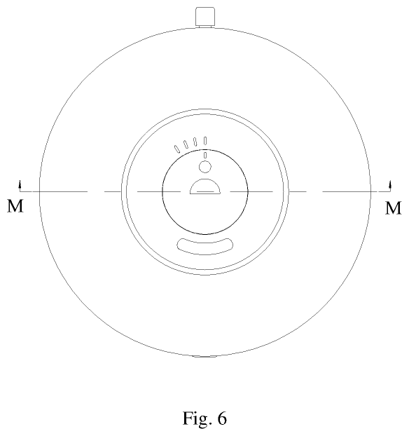

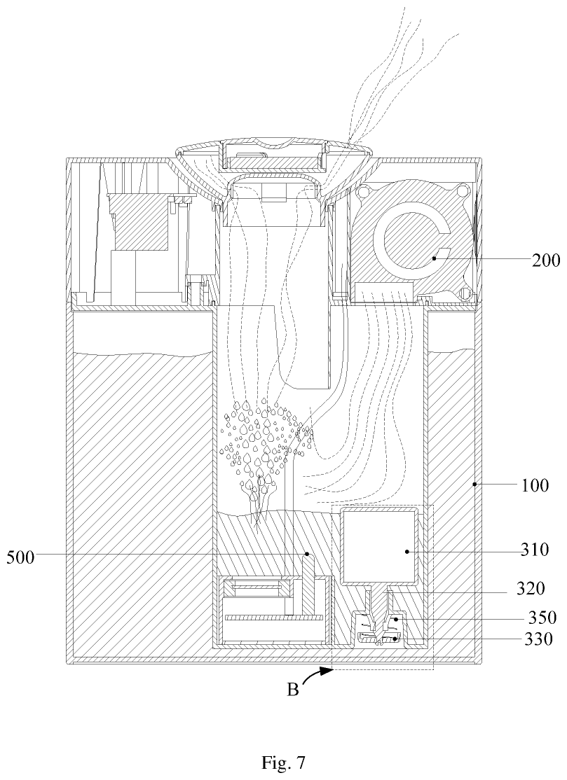

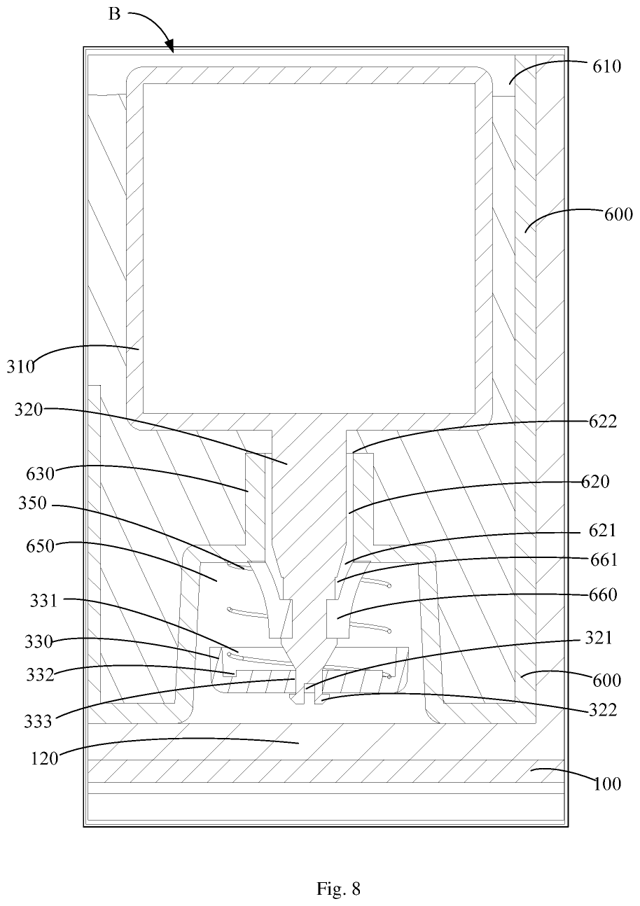

With reference to FIGS. 1-8, in the embodiment of the present application, the water replenishment structure 300 is used for a water storage container 600, a water inlet hole 620 is provided on a side wall or a bottom of the water storage container 600, the water replenishment structure 300 is provided corresponding to a water outlet end 622 of the water inlet hole 620;

the water replenishment structure 300 includes:

a floating member 310 located in the water storage container 600;

a linkage 320 whose one end connecting with the floating member 310, the other end extending out from the water storage container 600 through the water inlet hole 620, a radial size of the linkage 320 is smaller than that of the water inlet hole 620;

a sealing gasket 330 provided outside the water storage container 600 and provided corresponding to a water inlet end 621 of the water inlet hole 620, a radial size of the sealing gasket 330 is larger than that of the water inlet hole 620, the sealing gasket 330 is connected with a part of the linkage 320 extending out from the water storage container 600, in order to move with a movement of the linkage 320.

Specifically, in the present embodiment, there may be a plurality of the forms of the floating member 310, such as with a overall shape of a cylindrical, a cuboid, a cubic shape and so on, with a relatively small density and can float in water. One end of the linkage 320 is fixedly connected with the floating member 310. There are many connecting ways, such as plug connection, screw connection, snap connection and so on. Of course, in some embodiments, to simplify the manufacturing and installation process, the floating member 310 and the linkage 320 can be formed integrally. The cross section of the linkage 320 may be a circle, an ellipse and so on, and its radial size is smaller than that of the water inlet hole 620, so that the linkage 320 can move freely in the water inlet hole 620. The sealing gasket 330 is made of elastic material, which can be soft material such as rubber, silicone and so on. When the sealing gasket 330 is squeezed, the water inlet end 621 of the water inlet hole 620 can be sealed, and when the force suffered is sufficient, the deformation of the sealing gasket 330 can occur to improve the sealing performance. There can be a plurality of the cross-sectional shapes of the water inlet hole 620, such as a circle, an ellipse, a square, a triangle and so on, which for example corresponds to that of the linkage 320 in this embodiment.

The water storage container 600 is a container for storing liquid. There can be a plurality of the forms thereof, such as a tubular arrangement with one end open and the other end closed. The water inlet hole 620 can have many positions, such as on the side wall of the water storage container 600, on the bottom of the water storage container 600 and so on, which only need to allow the entrance of the liquid.

In the present embodiment, the floating member 310 and the sealing gasket 330 are arranged at the inside and the outside the liquid storage bucket respectively, and they are connected through the linkage 320, so that the liquid can enter the water storage container 600 from the gap between the linkage 320 and the water inlet hole 620 when it flows to the water inlet end 621 of the water inlet hole 620 at a certain pressure. As the liquid in the water storage container 600 increases, the floating member 310 will rise with the liquid level. As the floating member 310 rises, the linkage 320 drives the sealing member to move upward. When the liquid level reaches a preset position, the sealing gasket 330 is attached to the water inlet end 621 of the water inlet hole 620 to seal the water inlet end 621 to prevent the liquid from continuing to enter the water storage container 600. When the liquid in the water storage container 600 is consumed and the liquid level drops, the floating member 310 moves downward with the liquid level, and the sealing gasket 330 leaves the water inlet end 621 of the water inlet hole 620 as the floating member 310 moves downward, which makes the water inlet end 621 open, so that the liquid can continue to enter the water storage container 600 through the water inlet end 621.

In some embodiments, in order to adjust the amount of the liquid that can enter the water storage container 600, the water replenishment structure 300 further includes an elastic member 350 provided outside the water storage container 600, one end of the elastic member 350 corresponds to the outer side wall of the water storage container 600, and the other end is connected to the sealing gasket 330; and/or,

the elastic member 350 is provided inside the water storage container 600, one end of the elastic member 350 is fixedly connected with an inner side wall of the water storage container 600 around the water inlet hole 620, and the other end is fixedly connected with the linkage 320 or the floating member 310.

Specifically, in the present embodiment, there can be a plurality of the forms of the elastic member 350, such as an extension elastic structure, a compression elastic structure and so on. Specifically, it can be a spring, an elastic piece, a strip elastic member 350 similar to a rubber band and so on. Different elastic structures can be applied to different working conditions. Description is made taking a spring as an example in the following. The spring can be an extension spring or a compression spring. When the spring is an extension spring, the spring can be arranged between the floating member 310 and the inner side wall of the water storage container 600 below the floating member 310, and both ends of the spring are fixedly connected. When the liquid enters the liquid storage bucket from the water inlet hole 620 and raises the water level, it needs to overcome the elastic force of the extension spring itself. The elastic deformation of the spring occurs in the effect of the floating member 310, and is extended as the water level rises until the sealing gasket 330 blocks the water inlet end 621 of the water inlet hole 620 to prevent the water level from continuing to rise. During the rising of the water level, the spring has a restoring force of compression (pull the floating member 310 downward). When the liquid in the water storage container 600 is consumed and the liquid level drops, the floating member 310 moves toward the water outlet end 622 of the water inlet hole 620 (toward the initial position) in the effect of the elastic restoring force.

When the spring is a compression spring, it can be arranged between the sealing gasket 330 and the outer side wall of the water storage container 600, located below the water inlet hole 620, and one end of the compression spring is fixedly connected with the sealing gasket 330, the other end is provided corresponding to the water inlet end 621 of the water inlet hole 620 and may be connected with the outer side wall or not connected with the outer side wall, as long as it can abut against the outer side wall when moving to a preset position. When the liquid enters the liquid storage bucket from the water inlet hole 620 and raises the water level, it needs to overcome the elastic force of the compression spring itself. The elastic deformation of the spring occurs in the effect of the floating member 310, and is compressed as the water level rises until the sealing gasket 330 blocks the water inlet end 621 of the water inlet hole 620 to prevent the water level from continuing to rise. During the rising of the water level, the spring has a restoring force to expand (pull the floating member 310 upward) to restore the original length. When the liquid in the water storage container 600 is consumed and the liquid level drops, the floating member 310 moves toward the water outlet end 622 of the water inlet hole 620 (toward the initial position) in the effect of the elastic restoring force.

In some embodiments, in order to improve the installation stability of the elastic member 350, the elastic member 350 includes a spring sleeved on the linkage 320; there is a snap groove 332 on a side of the sealing gasket 330 facing the water inlet hole 620, and one end of the spring is stuck in the snap groove 332. When the spring is arranged outside the water storage container 600, the spring is sleeved on a part of the linkage 320 extending out from the water storage container 600, that is, the linkage 320 is sleeved on a part between the bottom of the water storage container 600 and the sealing gasket 330 of the linkage 320. The snap groove 332 is arranged annularly, and is opened in the circumferential direction of one side face of the sealing gasket 330, one end of the spring is stuck in the annular snap groove 332. In the present embodiment, the spring is sleeved on the linkage 320, so that the spring can be stably fit with the linkage 320, and the snap groove 332 is provided on the sealing gasket 330, so that the spring can be stably fit with the sealing gasket 330, thereby the stability of the fitting between the spring and the linkage 320 is further improved.

In some embodiments, in order to improve the sealing effect of the sealing gasket 330 on the water inlet end 621 of the water inlet hole 620, a deformation groove 331 is formed on the side of the sealing gasket 330 facing the water inlet hole 620, a notch of the deformation groove 331 allows the spring to get in and out the deformation groove 331, the snap groove 332 is formed on a groove bottom of the deformation groove 331. The notch of the deformation groove 331 is provided toward the water inlet end 621. When the sealing gasket 330 abuts against the outer side wall of the water storage container 600, as the water level continues to rise, the elastic deformation of the sealing gasket 330 will occur and the deformation groove 331 will be flattened. At this time, the attached area between the sealing gasket 330 and the side wall of the water storage tank is greatly increased, thereby being beneficial to improve its sealing performance. The snap groove 332 is provided at the bottom of the deformation groove 331, so that it can be used as a bending position during the deformation process, and the resistance that the sealing gasket 330 needs to overcome during the deformation process is reduced, which is beneficial to the deformation of the sealing gasket 330, and hence is beneficial to the make sealing gasket 330 to seal the water inlet end 621 better.

In some embodiments, in order to improve the convenience of connecting and disassembling the linkage 320 and the sealing gasket 330, a connection hole 333 is provided in a middle of the sealing gasket 330, an elastic groove 321 is provided at an end of the linkage 320 connected with the sealing gasket 330, and an inverted buckle 322 is provided on an outer side wall of the linkage 320. The elastic groove 321 penetrates along the radial direction of the end of the linkage 320, so that the elastic deformation of this end of the linkage 320 can occur. During the deformation, the parts on both sides of the linkage 320 are offset toward the elastic groove 321, making the radial size of this end be smaller. When the end of the linkage 320 is installed to the connection hole 333, the elastic groove 321 is squeezed so that the inverted buckle 322 passes through the connection hole 333 with the end, and extends after passing through the connection hole 333, so that the radial size of the inverted buckle 322 is larger than that of the connection hole 333. The radial size of the linkage 320 may be smaller than or equal to that of the connection hole 333. When the sealing gasket 330 is made of elastic material, the radial size of the linkage 320 may be larger than that of the connection hole 333, so that the linkage 320 is tightly fit with the connection hole 333. As such, when the linkage 320 is connected with and removed from the sealing gasket 330, it is only necessary to squeeze the elastic groove 321, and then the linkage 320 is inserted into or withdrawn from the connection hole 333, which greatly improves the convenience of assembling and assembling of the linkage 320 and the sealing gasket 330, and fully guarantees the reliability of the connection between the linkage 320 and the sealing gasket 330 meanwhile.

In some embodiments, in order to improve the reliability of sealing the water inlet hole 620, the water replenishment structure 300 further includes a sealing nozzle 660 having a water passage 661, the sealing nozzle 660 is provided corresponding to the water inlet end 621 of the water inlet hole 620 so that one end of the water passage 661 is intercommunicated with the water inlet end 621, and the other end is provided protruding from the water inlet hole 620. In the present embodiment, there may be a plurality of the shapes and the forms of the sealing nozzle 660, and a trumpet arrangement is taken as an example. An end of the sealing nozzle 660 is fixedly connected with the bottom of the water storage container 600, there are many ways of connection, such as snap connection, screw connection, clamping connection and so on. A large diameter end of the sealing nozzle 660 is intercommunicated with the water inlet hole 620, a small diameter end protrudes and extends in a direction away from the water storage container 600. Of course, the linkage 320 can pass through the water passage 661 to be connected with the sealing gasket 330. The radial size of the water passage 661 is larger than that of the linkage 320, so that water can flow through from the gap between the linkage 320 and the sealing nozzle 660. In some embodiments, the cross-sectional area of the water passage 661 at the small diameter end is smaller than that of the water inlet hole 620, which makes the sealing nozzle 660 to be blocked and sealed more easily, thereby improving the sealing performance of the sealing nozzle 660.

In the present embodiment, the sealing nozzle 660 and the water passage 661 on the sealing nozzle 660 are provided so that there is a gap between the blocked position and the outer wall of the water storage container 600, that is, in the case that the water inlet hole 620 is sealed, there is a gap between the middle part of the sealing gasket 330 and the bottom of the water storage container 600, where an auxiliary component, for example an elastic member, can be accommodate and installed. The sealing nozzle 660 is provided so that the sealed position protrudes from the bottom of the water storage container 600. When the sealing gasket 330 blocks an end of the sealing nozzle 660, there is an accommodate space for the spring provided between the middle of the sealing gasket 330 and the bottom of the water storage container 600, which is beneficial to improve the sealing performance. Of course, the blocked position is moved downward so that the distance between the sealing gasket and the blocked position decreases or the action force increases when the floating member 310 rises to the same height, which is beneficial to improve the sealing effect.

In some embodiments, in order to improve the stability of the movement of the linkage 320, a guiding sleeve 630 is provided at a position corresponding to the water inlet hole 620 on the inner side wall of the water storage container 600 to guide the linkage 320 to move along a preset direction. In the present embodiment, the vertical arrangement of the water inlet hole 620 is taken as an example for description. The guiding sleeve 630 is arranged vertically to surround the water outlet end 622 of the water inlet hole 620. The guiding sleeve 630 can be removably connected with the bottom of the water storage container 600, or can be provided integrally with the water storage container 600. The guiding sleeve 630 can be formed by extending from the hole wall of the water inlet hole 620 into the water storage container 600. The providing of the wire sleeve can ensure that the moving direction of the linkage 320 is kept vertically, thereby effectively avoiding the deviation of the linkage 320 which causes the phenomenon that the sealing gasket cannot block the water inlet hole 620, thereby greatly improving the reliability of the work of the water replenishment mechanism.

The present application further proposes an atomization device, which includes the water storage container 600, the atomizer 500, and the water replenishment structure 300. The specific structure of the water replenishment structure 300 refers to the above mentioned embodiments. Since the atomization device adopts all the technical solutions of all the above embodiments, it has at least all the beneficial effects brought by the technical solutions of the above mentioned embodiments, which will not be repeated here. Wherein the water replenishment structure 300 is installed corresponding to the water inlet hole 620 of the water storage container 600, the atomizer 500 is provided in the water storage container 600. The atomizer 500 atomizes the water in the water storage container 600 so as to deliver to a preset position, such as the air in the surrounding environment, to adjust the air humidity of the surrounding environment. It can also deliver to the aromatherapy structure to deliver the preset fragrance or perfume to the air in the surrounding environment.

The present application further proposes a humidifier, which includes a water tank 100 and an atomization device. The specific structure of the atomization device refers to the above mentioned embodiments. Since the humidifier adopts all the technical solutions of all the above mentioned embodiments, it has at least all the beneficial effects brought by the technical solutions of the above mentioned embodiments, which will not be repeated here. Wherein the water replenishment structure 300 of the atomization device is installed corresponding to the water inlet hole 620 of the water storage container 600, the water storage container 600 is intercommunicated with the water tank 100 through the water inlet hole 620.

The present application further proposes a humidifier, which includes the water tank 100, the water storage container 600, and the water replenishment structure 300. The specific structure of the water replenishment structure 300 refers to the above mentioned embodiments. Since the humidifier adopts all the technical solutions of all the above mentioned embodiments, it has at least all the beneficial effects brought by the technical solutions of the above mentioned embodiments, which will not be repeated here. Wherein the water replenishment structure 300 is installed corresponding to the water inlet hole 620 of the water storage container 600, the water storage container 600 is interconnected with the water tank 100 through the water inlet hole 620.

In some embodiments, in order to make full use of space and to improve the compactness of the structure, the water storage container 600 is installed in the water tank 100, the water inlet hole 620 is located at the bottom of the water storage container 600. There is a water inlet gap 120 between the bottom of the water storage container 600 and the bottom of the water tank 100. In the present embodiment, there is a plurality of the shapes of the water tank 100, such as a cylindrical configuration, which can be a circular or a square bucket and so on. The water storage container 600 is installed in the water tank 100, when there is enough liquid in the water tank 100, the liquid will enter the gap between the water tank 100 and the water storage container 600 in the effect of hydraulic pressure, and then enter the water storage container 600 through the water inlet hole 620. As such, while reducing the overall occupied space and improving the compactness of the structure, the water in the water tank 100 can be delivered to the water storage container 600 as much as possible to improve water utilization since the water inlet hole 620 is provided at the bottom of the water storage container 600 and the water pressure is relatively high. After the atomization device atomizes the liquid in the water storage container 600, the fan 200 in the humidifier extracts the gas in the atomization chamber 610 out to deliver to the air in the surrounding environment through the air outlet 210 to increase the air humidity.

In some embodiments, in order to further improve the compactness of the structure, an avoidance groove 650 is formed at a position of the water storage container 600 corresponding to the sealing gasket 330 to accommodate the sealing gasket 330; and/or a support table is formed at the opening of the box, the water storage container 600 includes a water storage part and a mounting plate 700 arranged around the bucket opening. The edge of the mounting plate 700 is overlapped on the support table 110.

Specifically, in the present embodiment, there is a plurality of the shapes of the avoidance groove 650, which can be cylinder, cuboid and so on, to match with the shape of the sealing gasket 330, so that the sealing gasket 330 can move freely in the avoidance groove 650. The avoidance groove 650 is provided to avoid the sealing gasket 330 from extending out to the area covered by the water storage container 600, that is, the sealing gasket 330 would not occupy a layered space alone, thereby the distance between the bottom of the water storage container 600 and the bottom wall of the water tank 100 is greatly reduced, which helps to improve the space utilization. The shape of the mounting plate 700 is equivalent to the cross-sectional shape of the water tank 100, for example a circular arrangement. The mounting plate 700 and the water storage container 600 may be fixedly connected, and in some embodiments, the two may also be formed integrally. The edge of the mounting plate 700 is overlapped on the support table 110, so that the mounting plate 700 can be fit with the water tank 100, and the installation and disassembly of the water storage container 600 and the water tank 100 is very convenient, to facilitate the convenient removal of the water storage container 600 from the water tank 100 to clean the water tank 100 and the water storage container 600.

The above are only preferred embodiments of the present application, and hence does not limit the patent scope of the present application. Under the concept of the utility model of the present application, the equivalent structure transformation made by using the content of the specification and drawings of the present application, or direct/indirect applications in other related technical fields are all included in the patent protection scope of the present application.

1. A water replenishment structure, wherein the water replenishment structure is used for a water storage container, a water inlet hole is provided on a side wall or a bottom of the water storage container, the water replenishment structure is provided corresponding to the water inlet hole;
the water replenishment structure comprises:
a floating member located in the water storage container;
a linkage whose one end connecting with the floating member, another end extending out from the water storage container through the water inlet hole, a radial size of the linkage is smaller than that of the water inlet hole;
a sealing gasket provided outside the water storage container and provided corresponding to a water inlet end of the water inlet hole, a radial size of the sealing gasket is larger than that of the water inlet hole, the sealing gasket is connected with a part of the linkage extending out from the water storage container to move with a movement of the linkage.

2. The water replenishment structure according to claim 1, wherein the water replenishment structure further comprises an elastic member provided outside the water storage container, one end of the elastic member corresponds to an outer side wall of the water storage container, and the other end is connected with the sealing gasket.

3. The water replenishment structure according to claim 2, wherein the elastic member is provided inside the water storage container, one end of the elastic member is fixedly connected with an inner side wall of the water storage container around the water inlet hole, and the other end is fixedly connected with the linkage or the floating member.

4. The water replenishment structure according to claim 2, wherein the elastic member comprises a spring sleeved on the linkage;
there is a snap groove on a side of the sealing gasket facing the water inlet hole, and one end of the spring is stuck in the snap groove.

5. The water replenishment structure according to claim 4, wherein a deformation groove is formed on the side of the sealing gasket facing the water inlet hole, a notch of the deformation groove allows the spring to get in and out the deformation groove, the snap groove is formed on a groove bottom of the deformation groove.

6. The water replenishment structure according to claim 3, wherein the elastic member comprises a spring sleeved on the linkage.

7. The water replenishment structure according to claim 1, wherein a connection hole is provided in a middle of the sealing gasket, one end of the linkage fitting with the sealing gasket is inserted into the connection hole;
an end of the linkage connected with the sealing gasket is provided with an elastic groove, and an inverted buckle is provided on an outer side wall of the linkage.

8. The water replenishment structure according to claim 1, wherein a guiding sleeve is provided at a position corresponding to the water inlet hole on an inner side wall of the water storage container to guide the linkage to move along a preset direction.

9. The water replenishment structure according to claim 1, wherein the water replenishment structure further comprises a sealing nozzle having a water passage, the sealing nozzle is provided corresponding to the water inlet end of the water inlet hole so that one end of the water passage is intercommunicated with the water inlet end, and the other end is provided protruding from the water inlet hole.

10. The water replenishment structure according to claim 9, wherein the sealing nozzle is provided in a trumpet shape, a large diameter end of the sealing nozzle is fixedly connected with an outer side wall of the water storage container corresponding to the water inlet end of the water inlet hole, a small diameter end protrudes and extends in a direction away from the water inlet hole.

11. The water replenishment structure according to claim 4, wherein the water replenishment structure further comprises a sealing nozzle having a water passage, the sealing nozzle is provided corresponding to the water inlet end of the water inlet hole so that one end of the water passage is intercommunicated with the water inlet end, and the other end is provided protruding from the water inlet hole.

12. The water replenishment structure according to claim 5, wherein the water replenishment structure further comprises a sealing nozzle having a water passage, the sealing nozzle is provided corresponding to the water inlet end of the water inlet hole so that one end of the water passage is intercommunicated with the water inlet end, and the other end is provided protruding from the water inlet hole.

13. An atomization device, wherein the atomization device comprises a water storage container, an atomizer and a water replenishment structure, a water inlet hole is provided on a side wall or a bottom of the water storage container, the water replenishment structure is provided corresponding to the water inlet hole;
the water replenishment structure comprises:
a floating member located in the water storage container;
a linkage whose one end connecting with the floating member, another end extending out from the water storage container through the water inlet hole, a radial size of the linkage is smaller than that of the water inlet hole;
a sealing gasket provided outside the water storage container and provided corresponding to a water inlet end of the water inlet hole, a radial size of the sealing gasket is larger than that of the water inlet hole, the sealing gasket is connected with a part of the linkage extending out from the water storage container to move with a movement of the linkage;
the atomizer is provided inside the water storage container.

14. The atomization device according to claim 13, wherein the water replenishment structure further comprises an elastic member provided outside the water storage container, one end of the elastic member corresponds to an outer side wall of the water storage container, and the other end is connected with the sealing gasket, or
the elastic member is provided inside the water storage container, one end of the elastic member is fixedly connected with an inner side wall of the water storage container around the water inlet hole, and the other end is fixedly connected with the linkage or the floating member.

15. The atomization device according to claim 14, wherein the elastic member comprises a spring sleeved on the linkage;
there is a snap groove on a side of the sealing gasket facing the water inlet hole, and one end of the spring is stuck in the snap groove;
a deformation groove is formed on the side of the sealing gasket facing the water inlet hole, a notch of the deformation groove allows the spring to get in and out the deformation groove, the snap groove is formed on a groove bottom of the deformation groove.

16. A humidifier, wherein the humidifier comprises a water tank and an atomization device;
the atomization device comprises a water storage container, an atomizer, and a water replenishment structure, a water inlet hole is provided on a side wall or a bottom of the water storage container, the water replenishment structure is provided corresponding to the water inlet hole;
the water replenishment structure comprises:
a floating member located in the water storage container;
a linkage whose one end connecting with the floating member, the other end extending out from the water storage container through the water inlet hole, a radial size of the linkage is smaller than that of the water inlet hole;
a sealing gasket provided outside the water storage container and provided corresponding to a water inlet end of the water inlet hole, a radial size of the sealing gasket is larger than that of the water inlet hole, the sealing gasket is connected with a part of the linkage extending out from the water storage container to move with a movement of the linkage;
the water replenishment structure is installed corresponding to the water inlet hole of the water storage container, the atomizer is provided inside the water storage container;
the water storage container is intercommunicated with the water tank through the water inlet hole.

17. The humidifier according to claim 16, wherein the water storage container is installed inside the water tank, the water inlet hole is located at a bottom of the water storage container, there is a water inlet gap between the bottom of the water storage container and the bottom of the water tank.

18. The humidifier according to claim 16, wherein an avoidance groove is formed at a position of the water storage container corresponding to the sealing gasket to accommodate the sealing gasket.

19. The humidifier according to claim 16, wherein a support table is formed at the opening of a box, the water storage container comprises a water storage part and a mounting plate arranged around an opening of the water storage part, an edge of the mounting plate is overlapped on the support table.

20. The humidifier according to claim 16, wherein the water replenishment structure further comprises an elastic member provided outside the water storage container, one end of the elastic member corresponds to an outer side wall of the water storage container, and the other end is connected with the sealing gasket; or,
the elastic member is provided inside the water storage container, one end of the elastic member is fixedly connected with an inner side wall of the water storage container around the water inlet hole, and the other end is fixedly connected with the linkage or the floating member.
